(19) United States
(12) Patent Application Publication
(10) Pub. No.: US 2005/0167931 A1
(43) Pub. Date: Aug. 4, 2005

(54) Low cost gaskets manufactured from conductive loaded resin-based materials

(75) Inventor: Thomas Aisenbrey, Littleton, CO (US)

Correspondence Address: STEPHEN B. ACKERMAN, 28 DAVIS AVENUE, POUGHKEEPSIE, NY, 12603, US

(73) Assignee: Integral Technologies, Inc.

(21) Appl. No.: 11/086,852

(22) Filed: Mar. 22, 2005

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/558,628, filed on Apr. 1, 2004.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. H01B 7/00

(52) U.S. Cl. 277/650

(57) ABSTRACT

Conductive gaskets are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel plated carbon fiber, stainless steel fiber, copper fiber, silver fiber, aluminum fiber, or the like.

This Patent Application claims priority to the U.S. Provisional Patent Application 60/558,628 filed on Apr. 1, 2004, which is herein incorporated by reference in its entirety.

This Patent application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001.

### BACKGROUND OF THE INVENTION

(1) Field of the Invention

This invention relates to conductive gaskets and, more particularly, to conductive gaskets molded of conductive loaded resin-based materials comprising micron conductive powders, micron conductive fibers, or a combination thereof, substantially homogenized within a base resin when molded. This manufacturing process yields a conductive part or material usable within the EMF or electronic spectrum(s).

(2) Description of the Prior Art

Conductive gasket materials are used in the art of electronics circuits to prevent propagation of electrostatic discharge (ESD) or electromagnetic interference (EMI). Electronic circuits are frequently sensitive to ESD or EMI. In an ESD event, external static charging as high as about 10,000 volts can be discharged, accidentally, through an electronic device. To protect the device, a substantial grounding path is typically designed into the device to shunt the discharge energy away from the electronic circuit and into the housing, cabinet, or chassis of the device. Electromagnetic interference can be an issue of radiation outward from the electronic device that causes problems for nearby devices. Alternatively, external EMI sources can radiate energy into the electronics device to cause operating problems therein. In either case, the housing, cabinet, or chassis of the electronic device can be used as a shielding cage to prevent radiated EMI into or out from the device.

To affect a substantial grounding plane and/or a shielding cage, housings, cabinets, or chassis for electronic circuits are frequently constructed of conductive materials. Typical examples of these conductive materials include stamped metal, cast metal, or forged metal such as aluminum, zinc, and the like. Since the electronic device typically requires external connectivity, via wiring, to external power sources and/or input and output signals, these housings, cabinets, or chassis typically have openings for electrically connectors. In addition, the electrical circuit components, such as printed circuit board, integrated circuits, capacitors, resistors, and the like, must be assembled into the housing, cabinet, or chassis and may, at a later time, need to be accessible for servicing. Therefore, the housings, cabinets, or chassis are typically of two-piece construction.

These points of accessibility into the housing, cabinet, or chassis typically require the use of sealing devices. Gaskets are used to seal connector openings and case mating points to prevent moisture and other contamination from entering the housing, cabinet, or chassis. In addition, these points of accessibility create leakage paths for ESD and EMI signals. To provide environmental and electrical sealing, conductive gasket material is typically used. This material combines a flexible penetration barrier with a conductive characteristic. A typical prior art conductive gasket comprises metal or a metal coated laminate. This metal-based gasket is conductive. However, the gasket material is not ideal from a sealing perspective and is subject to corrosion. Corrosion is a serious concern that reduces the lifetime, the electrical contact and the performance of prior art metal gasket materials.

Typical prior art gaskets are metals or alloys of metals such as copper, copper-beryllium, stainless steel, nickel-plated copper, etc. that are fabricated to form the gaskets. Other gasket materials are formed of foamed plastic resins that are plated to create a compressible gasket. Alternately, the gaskets have a compressible foam core covered with a highly conductive metallized fabric.

Several prior art inventions relate to conductive gaskets for EMI or ESD protection. U.S. Pat. No. 4,769,280 to Powers teaches electromagnetic shielding in the form of gaskets, caulking compounds, adhesives, and coatings comprising a resin matrix loaded with electrically conductive solid metal particles having at least three separate layers of metal. The invention also teaches the solid metal particles to have an inner core of aluminum, a first layer of tin, zinc or nickel and an outer layer of silver. U.S. Pat. No. 6,818,822 B1 to Gilliland et al teaches a conductive gasket with an internal contact-enhancing strip. This invention utilizes pointed metal protrusions inside the gasket that will make electrical contact with the intended item when the gasket is compressed. U.S. Pat. No. 6,309,742 B1 to Clupper et al teaches an EMI/RFI shielding gasket that utilizes an open-celled foam substrate having a metal coating on its skeletal structure. The invention teaches the metal coating to be copper, nickel, tin, gold, silver, cobalt or palladium and preferably nickel. U.S. Pat. No. 6,653,556 B2 to Kim teaches a gasket comprising a non-conductive elastic core with a flexible conductive cloth covering the outer surface that is secured with a hot-melt adhesive and covered with pressure sensitive tape. U.S. Pat. No. 5,286,568 to Bacino et al teaches an electrically conductive gasket comprising a substrate layer of polytetrafluoroethylene with a conductive filler in the matrix and a coating comprising a copolymer of tetrafluoroethylene and a fluorinated co monomer having electrically conductive particles therein.

U.S. Pat. No. 5,115,104 to Bunyan teaches an EMI/RFI shielding gasket that is formed by applying a tacky, slow drying adhesive onto a resilient core material and applying a coating of metal fibers or metal coated fibers by electrostatic deposition. This invention also teaches that the resilient core material can be made conductive by adding conductive fillers to the matrix when maximum electrical conductivity is desired. U.S. Pat. No. 5,070,216 to Thornton teaches an EMI shielding gasket that utilizes a plastic substrate with a metal outer layer that makes electrical contact with the desired item. This invention also teaches that the gasket can be formed with a metal layer on both sides of the plastic substrate. U.S. Pat. No. 4,678,863 to Reese et al teaches an electrically conductive corrosion resistant gasket that utilizes an elastomer containing metal particles which contain silver. This conductive elastomer is then dipped in solder to provide an electrically conductive gasket that does not induce corrosion in aluminum items when in contact with them. U.S. Pat. No. 4,594,472 to Brettle et al teaches a conductive gasket for use in electromagnetic interference protection of electrical apparatuses. This invention utilizes carbon fibers that are in the range of 5 to 20 microns in diameter and ½ to 10 mm in length at a loading of 4 to 7% by weight.

U.S. Patent Publication U.S. 2003/0124934 A1 to Bunyan et al teaches a flame retardant EMI shielding gasket that is formed with a resilient core member layer, an electrically conductive fabric layer, and a flame retardant layer. This invention teaches the electrically conductive fabric layer to be a metal-plated cloth. U.S. Patent Publication U.S. 2004/0172502 A1 to Lionetta et al teaches a composite EMI shield that utilizes a first conductive layer of a thin metal sheet, screen or metal-plated fabric, and a second layer of a polymeric composition having electrically conductive fillers within. U.S. Patent Publication U.S. 2002/0160193 A1 to Hajmrle et al teaches using a silver coating on a nickel coating on a graphite core as a conductive filler to create EMI/RFI shielding items. U.S. Patent Publication U.S. 2002/0129953 A1 to Miska teaches an abrasion resistant conductive film and gasket that utilizes a closed cell urethane foam core that is covered by a polymeric film having a plurality of peaks covered by a conductive metal layer over both the peaks and plane of the surface. U.S. Patent Publication U.S. 2004/0247851 A1 to Leerkamp teaches a radiation shielding gasket and manufacturing method that utilizes a thin layer of metal over an anisotropic plastic foam.

### SUMMARY OF THE INVENTION

A principal object of the present invention is to provide an effective conductive gasket.

A further object of the present invention is to provide a conductive gasket exhibiting high electrical conductivity.

A further object of the present invention is to provide a conductive gasket exhibiting high thermal conductivity.

A further object of the present invention is to provide a conductive gasket further exhibiting magnetic capability.

A further object of the present invention is to provide a conductive gasket comprising a conductive mesh or fabric.

A yet further object of the present invention is to provide a conductive gasket molded of conductive loaded resin-based material where the visual, conductive, or thermal characteristics can be altered by further forming a metal layer over the conductive loaded resin-based material.

A yet further object of the present invention is to provide methods to fabricate a conductive gasket from a conductive loaded resin-based material incorporating various forms of the material.

In accordance with the objects of this invention, a conductive gasket device is achieved. The device comprises a conductive loaded resin-based material comprising conductive materials in a base resin host.

Also in accordance with the objects of this invention, a conductive gasket device is achieved. The device comprises a structural layer of conductive loaded resin-based material comprising conductive materials in a base resin host. The weight of the conductive materials is between 20% and 50% of the total weight of the conductive loaded resin-based material. An adhesive layer is adhered to the structural layer.

Also in accordance with the objects of this invention, a conductive gasket device is achieved. The device comprises a structural layer of conductive loaded resin-based material comprising micron conductive fiber in a base resin host. The weight of the micron conductive fiber is between 20% and 50% of the total weight of the conductive loaded resin-based material. A first adhesive layer is adhered to the structural layer. A second adhesive layer is adhered to the structural layer on the side opposite the first adhesive layer.

Also in accordance with the objects of this invention, a method to form a conductor gasket device is achieved. The method comprises providing a conductive loaded, resin-based material comprising conductive materials in a resin-based host. The conductive loaded, resin-based material is formed into a conductive gasket.

Also in accordance with the objects of this invention, a method to form a conductive gasket device is achieved. The method comprises providing a conductive loaded, resin-based material comprising conductive materials in a resin-based host. The weight of the conductive materials is between 20% and 50% of the total weight of the conductive loaded resin-based material. The conductive loaded, resin-based material is formed into a structural layer. An adhesive layer is adhered to the structural layer.

Also in accordance with the objects of this invention, a method to form a conductive gasket is achieved. The method comprises providing a conductive loaded, resin-based material comprising micron conductive fiber in a resin-based host. The percent by weight of the micron conductive fiber is between 25% and 35% of the total weight of the conductive loaded resin-based material. The conductive loaded, resin-based material is formed into a structural layer. A first adhesive layer is adhered to the structural layer. A second adhesive layer is adhered to the structural layer on the side opposite the first adhesive layer.

### BRIEF DESCRIPTION OF THE DRAWINGS

In the accompanying drawings forming a material part of this description, there is shown:

FIG. 1 illustrates a first preferred embodiment of the present invention showing a conductive gasket comprising conductive loaded resin-based material.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold conductive gaskets of a conductive loaded resin-based material.

FIG. 7 illustrates a second preferred embodiment of the present invention showing an “O” ring conductive gasket comprising conductive loaded resin-based material.

### DESCRIPTION OF THE PREFERRED EMBODIMENTS

This invention relates to conductive gaskets molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of conductive gaskets fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the conductive gasket devices are substantially homogenized together using molding techniques and or methods such as injection molding, over-molding, insert molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of conductive gaskets significantly lowers the cost of materials and the design and manufacturing processes used to hold ease of close tolerances, by forming these materials into desired shapes and sizes. The conductive gaskets can be manufactured into infinite shapes and sizes using conventional forming methods such as injection molding, over-molding, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. The micron conductive powders can be of carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers can be nickel plated carbon fiber, stainless steel fiber, copper fiber, silver fiber, aluminum fiber, or the like, or combinations thereof. Superconductor metals, such as titanium, nickel, niobium, and zirconium, and alloys of titanium, nickel, niobium, and zirconium may also be used as micron conductive fibers in the present invention. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion to create desired shapes and sizes. The molded conductive loaded resin-based materials can also be stamped, cut or milled as desired to form create the desired shape form factor(s) of the conductive gaskets. The doping composition and directionality associated with the micron conductors within the loaded base resins can affect the electrical and structural characteristics of the conductive gaskets and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming conductive gaskets that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in conductive gasket applications as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, conductive gaskets manufactured from the molded conductor loaded resin-based material can provide added thermal dissipation capabilities to the application. For example, heat can be dissipated from electrical devices physically and/or electrically connected to conductive gaskets of the present invention.

As a significant advantage of the present invention, conductive gaskets constructed of the conductive loaded resin-based material can be easily interfaced to an electrical circuit or grounded. In one embodiment, a wire can be attached to a conductive loaded resin-based conductive gaskets via a screw that is fastened to the conductive gasket. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the conductive gasket and a grounding wire.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary non-ferromagnetic conductor fibers include stainless steel, nickel, copper, silver, aluminum, or other suitable metals or conductive fibers, alloys, plated materials, or combinations thereof. Superconductor metals, such as titanium, nickel, niobium, and zirconium, and alloys of titanium, nickel, niobium, and zirconium may also be used as micron conductive fibers in the present invention. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials.

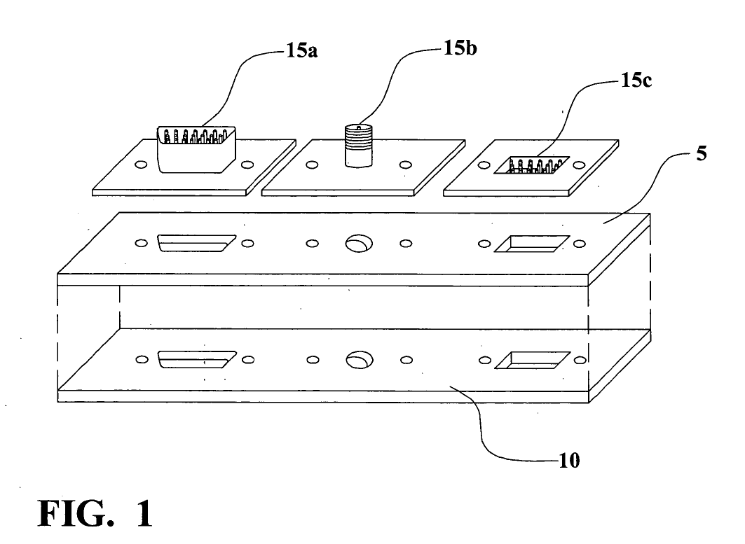

Referring now to FIG. 1 a first preferred embodiment of the present invention is illustrated. A very low cost, flexible, conductive gasket comprising a conductive loaded resin-based material is shown. Several important features of the present invention are shown and discussed below. The first preferred embodiment shows a gasket 5 formed of the conductive loaded resin-based material of the present invention. The gasket 5 has openings 12a, 12b, and 12c to allow connectors 15a, 15b, and 15c to enter a chassis 10 of an electronic or computer system. The gasket 5 provides a conductive path between the connectors 15a, 15b, and 15c and the chassis 10, while providing an environmental seal for the chassis 10 to prevent the entrance of contamination or moisture into the chassis 10.

In one embodiment, the conductive loaded resin-based material 5 is first formed into a thin sheet. In one embodiment, the thin sheet is formed by extruding molten conductive loaded resin-based material through an opening. In another embodiment, the thin sheet is formed by calendaring the conductive loaded resin-based material. In a calendaring process, the material is progressively thinned by pressing and rolling. After the thin sheet of conductive loaded resin-based material is formed, the sheet is pressed to cut to the desired conductive gasket 5 shape and to cut openings 12a, 12b, and 12c for connectors 15a, 15b, 15c. In another embodiment, the conductive loaded resin-based material is molded by, for example, injection molding to form the desired shape and openings.

In another embodiment, an adhesive layer 14 is applied to the gasket 5 after the gasket 5 is shaped. In one embodiment, the adhesive layer 14 is rolled onto the gasket 5. In another embodiment, the adhesive layer 14 is applied by spraying. In another embodiment, the adhesive layer 14 is co-extruded with the gasket 5. The adhesive layer 14 may comprise any of several types of materials, depending on the application. In one embodiment, the adhesive layer 14 is a pressure sensitive adhesive (PSA). In this case, the adhesive 14 is a resin-based material having a glass transition temperature or other surface properties that cause the material to exhibit tackiness at normal room temperature. In this case, the gasket 5 is applied to an object and pressed into place. The tackiness of the adhesive 14 will maintain the gasket 5 placement. In another embodiment, the adhesive 14 comprises a thermosetting resin-based material. In this case, the adhesive may not exhibit tackiness at room temperature. However, the adhesive 14 will bond with the surface of the object to which has been applied when subjected to heating or other chemical reaction.

The conductive gasket 5 provides a conductive path wherever it is applied. Therefore, if the conductive chassis 10 is designed to act as a shielding cage, then the conductive gasket continues the shielding effect and eliminates EMI or ESD leakage around the connectors 15a, 15b, and 15c. The conductive loaded resin-based material of the conductive gasket 5 absorbs electromagnetic energy. If the conductive chassis 10 is designed to act as a ground plane, then the conductive gasket 5 continues the grounding connection. In addition, where the conductive gasket 5 is applied, it is useful for forming an environmental seal to prevent contamination or moisture entrance into the chassis 10 around the connectors 15a, 15b, and 15c.

In yet another embodiment, a ferromagnetic material is added to the conductive loaded resin-based material of the present invention, as described above, so that a magnetic or magnetizable material is produced. Where the ferromagnetic conductive loaded resin-based material is formed into the conductive gasket 5, then a magnetized or magnetizable gasket 5 is produced.

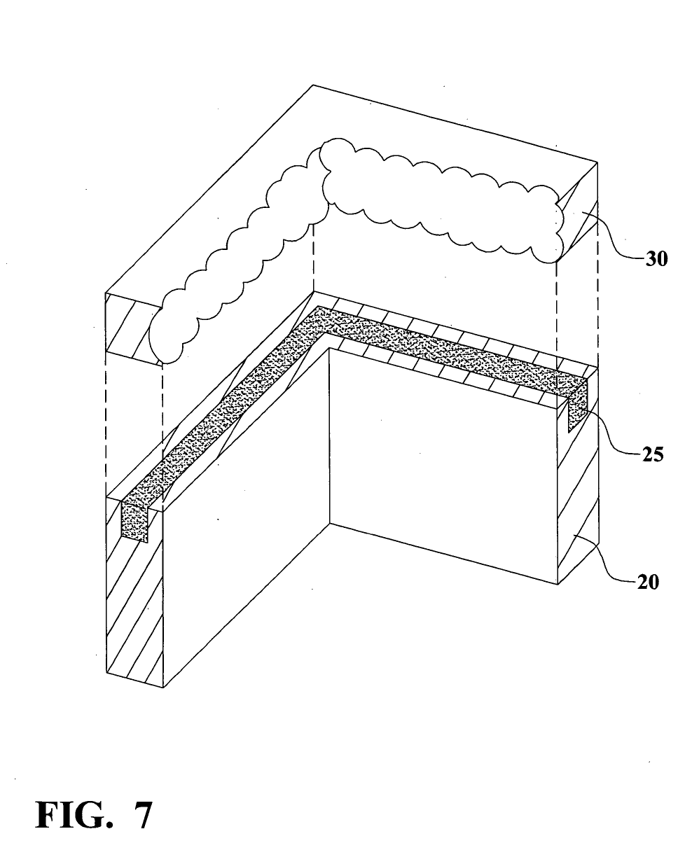

Referring to FIG. 7 a second preferred embodiment of the present invention is illustrated. An “O” ring conductive gasket 25 is shown. A cabinet or chassis 20 is illustrated with a door or cover 30 that provides access to the material or electronics within the chassis 20. The chassis 20 has a groove into which a circular or “O” shaped gasket material 25 of conductive loaded resin-based material is applied. The door or cover 30 is attached to the chassis 20 and secured. The gasket material 25 is deformed to provide a tight electrical connection between the chassis 20 and the door or cover 30. Again, the gasket material 25 provides an environmental seal for the chassis 20 to prevent contamination or moisture entering the chassis 20. Further, the electrical connection of the chassis 20 and the door or cover 30 through the gasket material 25 provides electromagnetic interference (EMI) and electrostatic discharge (ESD) protection for the material or electronic circuits within the chassis 20.

The gasket material as described is manufactured of conductive loaded resin-based materials comprising micron conductive powders, micron conductive fibers, or a combination thereof, homogenized within a base resin. The conductive loaded resin-based materials may be cut, stamped, or vacuumed formed from an injection molded or extruded sheet or bar stock, over-molded, laminated, milled or the like to provide the desired gasket shape and size. The conductive gaskets of FIGS. 1 and 7 are exemplary. The gasket material may be shaped into any form necessary for an application.

The conductive loaded resin-based gasket material may be further applied to any type and shape of gasket. The formation of gasket material from the conductive loaded resin-based materials reduces gasket cost, part counts, manufacturing costs, and weight as well as eliminating corrosion and oxidation problems found in the prior art.

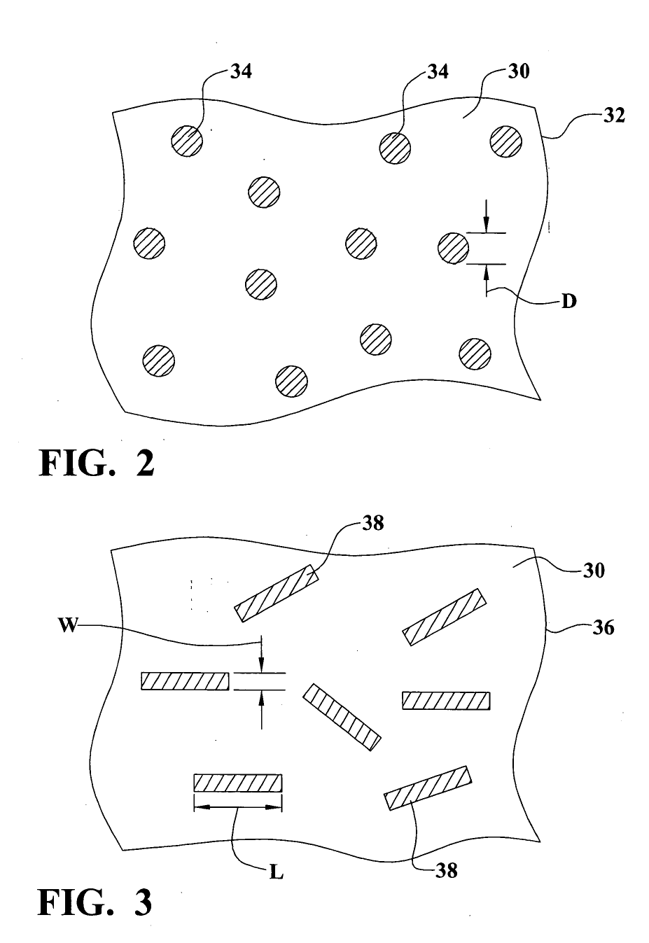

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

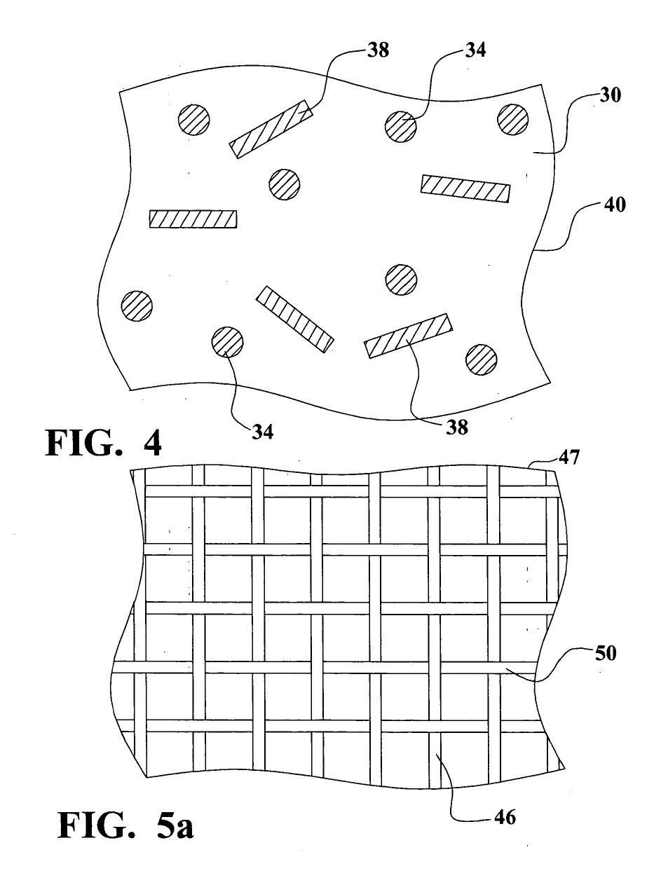

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, aluminum, or other suitable metals or conductive fibers, or combinations thereof. Superconductor metals, such as titanium, nickel, niobium, and zirconium, and alloys of titanium, nickel, niobium, and zirconium may also be used as micron conductive fibers in the present invention. These conductor particles and or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

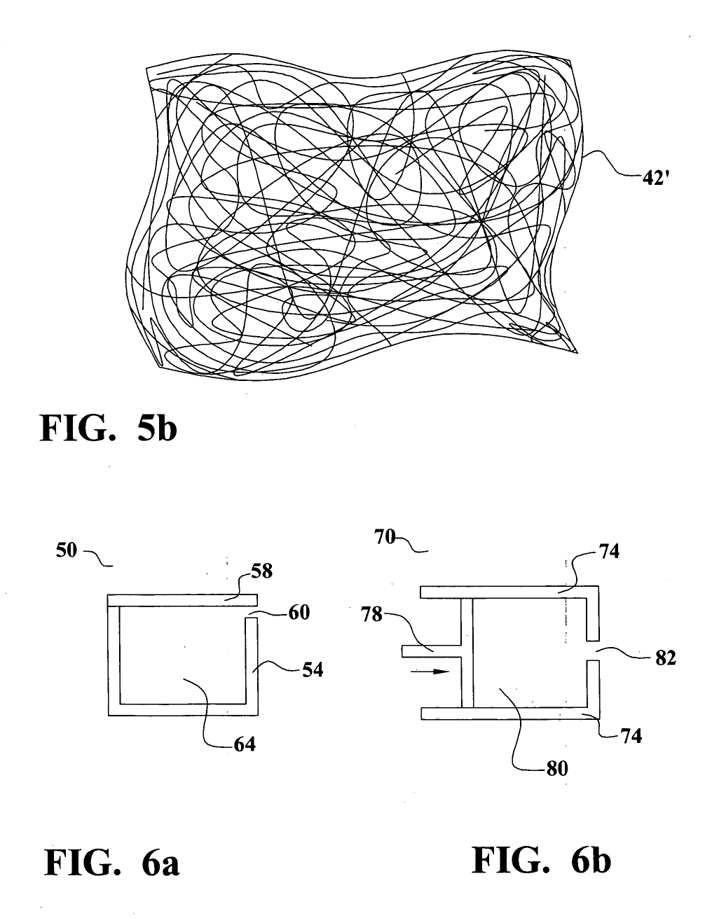

Conductive gaskets formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the conductive gaskets are removed.

FIG. 6b shows a simplified schematic diagram of an extruder 70 for forming conductive gaskets using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective conductive gasket is achieved. The conductive gasket exhibits high electrical conductivity, high thermal conductivity. The conductive gasket exhibits excellent electromagnetic energy absorption. The conductive gasket may further exhibit magnetic capability. The conductive gasket may further comprising a conductive mesh or fabric. The conductive gasket may further comprise a metal layer over the conductive loaded resin-based material. Methods to fabricate the conductive gasket from a conductive loaded resin-based material incorporating various forms of the material are achieved.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A conductive gasket device comprising a conductive loaded resin-based material comprising conductive materials in a base resin host.

2. The device according to claim 1 wherein the percent by weight of said conductive materials is between about 20% and about 50% of the total weight of said conductive loaded resin-based material.

3. The device according to claim 1 wherein said conductive materials comprise micron conductive fiber.

4. The device according to claim 2 wherein said conductive materials further comprise conductive powder.

5. The device according to claim 1 wherein said conductive materials are metal.

6. The device according to claim 1 further comprising an adhesive layer adhered to said conductive loaded resin-based material.

7. The device according to claim 6 further comprising a second adhesive layer adhered to said conductive loaded resin-based material on the side opposite said adhesive layer.

8. The device according to claim 1 wherein said conductive loaded resin-based material comprises a fabric or mesh of said conductive loaded resin-based material.

9. The device according to claim 1 wherein said conductive loaded resin-based material further comprises ferromagnetic loading such that said conductive gasket is magnetic.

10. The device according to claim 1 further comprising a metal layer overlying said conductive gasket.

11. A conductive gasket device comprising:
a structural layer of conductive loaded resin-based material comprising conductive materials in a base resin host wherein the weight of said conductive materials is between 20% and 50% of the total weight of said conductive loaded resin-based material; and
an adhesive layer adhered to said structural layer.

12. The device according to claim 11 wherein said conductive materials are nickel plated carbon micron fiber, stainless steel micron fiber, copper micron fiber, silver micron fiber or combinations thereof.

13. The device according to claim 11 wherein said conductive materials comprise micron conductive fiber and conductive powder.

14. The device according to claim 13 wherein said conductive powder is nickel, copper, or silver.

15. The device according to claim 13 wherein said conductive powder is a non-conductive material with a metal plating of nickel, copper, silver, or alloys thereof.

16. The device according to claim 11 further comprising a second adhesive layer adhered to said structural layer on the side opposite said adhesive layer.

17. The device according to claim 11 wherein said structural layer comprises a fabric or mesh of said conductive loaded resin-based material.

18. The device according to claim 11 wherein said conductive loaded resin-based material further comprises ferromagnetic loading such that said structural layer is magnetic.

19. The device according to claim 11 further comprising a metal layer overlying said structural layer.

20. A conductive gasket device comprising:
a structural layer of conductive loaded resin-based material comprising micron conductive fiber in a base resin host wherein the weight of said micron conductive fiber is between 20% and 50% of the total weight of said conductive loaded resin-based material;
a first adhesive layer adhered to said structural layer; and
a second adhesive layer adhered to said structural layer on the side opposite said first adhesive layer.

21. The device according to claim 20 wherein said micron conductive fiber is stainless steel.

22. The device according to claim 20 further comprising conductive powder.

23. The device according to claim 20 wherein said micron conductive fiber has a diameter of between about 3 μm and about 12 μm and a length of between about 2 mm and about 14 mm.

24. The device according to claim 20 wherein said structural layer comprises a fabric or mesh of said conductive loaded resin-based material.

25. The device according to claim 20 wherein said conductive loaded resin-based material further comprises ferromagnetic loading such that said structural layer is magnetic.
